(19) United States
(12) Patent Application Publication
(10) Pub. No.: US 2024/0203380 A1
(43) Pub. Date: Jun. 20, 2024

(54) MUSICAL INSTRUMENT

(71) Applicant: YAMAHA CORPORATION, Hamamatsu-shi (JP)

(72) Inventor: Takuya SHIBATA, Hamamatsu-shi (JP)

(21) Appl. No.: 18/595,650

(22) Filed: Mar. 5, 2024

Related U.S. Application Data
(63) Continuation of application No. PCT/JP22/28617, filed on Jul. 25, 2022.

(30) Foreign Application Priority Data
Sep. 21, 2021 (JP) 2021-152912

(51) Int. Cl. G10D 3/02; G10D 1/08; G10H 1/00; G10H 1/14; G10H 1/18; G10H 3/18

(52) U.S. Cl. CPC G10D 3/02; G10D 1/085; G10H 1/0091; G10H 1/14; G10H 1/18; G10H 3/186; G10H 2220/461

(57) ABSTRACT

A musical instrument includes: a musical instrument body configured to reverberate by vibrating at least one vibrating member in accordance with a performance operation; a pickup configured to output a performance information signal corresponding to the performance operation; a microphone disposed in a vicinity of the musical instrument body and configured to output a sound collection signal corresponding to sounds around the musical instrument body; and a vibrator configured to vibrate the musical instrument body based on the performance information signal and the sound collection signal.

### CROSS-REFERENCE TO RELATED APPLICATIONS

The present application is a continuation application of International Application No. PCT/JP2022/028617, filed Jul. 25, 2022, which claims priority to Japanese Patent Application No. 2021-152912, filed Sep. 21, 2021. The contents of these applications are incorporated herein by reference.

### BACKGROUND

### Technical Field The present disclosure relates to a musical instrument.

### Background Art

Heretofore, there are some musical instruments that emit sound by vibrating a soundboard or the like using a vibration unit in response to a performance operation. As such a musical instrument, Japanese Patent Publication No. 6525068 discloses an acoustic guitar that includes a pickup that outputs an electric signal (performance information signal) corresponding to the vibration of a string, and a vibration unit that vibrates the body according to the electric signal. The body of this acoustic guitar functions as a speaker that outputs sound according to the performance, and therefore, the acoustic guitar can be played without the need for a separate speaker.

### SUMMARY OF INVENTION

A performer may perform singing while playing a musical instrument such as an acoustic guitar. However, in order to output the performer's singing voice as an audio signal (electrical signal) from a speaker, it is necessary to prepare equipment (for example, a microphone and a speaker) separate from the musical instrument, which is troublesome.

The present disclosure has been made in view of the circumstances described above. An example of an object of the present invention is to provide a musical instrument capable of reducing equipment preparation for singing and playing a musical instrument at the same time.

A first aspect of the present disclosure is a musical instrument including: a musical instrument body configured to reverberate by vibrating at least one vibrating member in accordance with a performance operation; a pickup configured to output a performance information signal corresponding to the performance operation; a microphone disposed in a vicinity of the musical instrument body and configured to output a sound collection signal corresponding to sounds around the musical instrument body; and a vibrator configured to vibrate the musical instrument body based on the performance information signal and the sound collection signal.

### BRIEF DESCRIPTION OF THE DRAWINGS

FIG. 1 is a front elevation view showing a guitar according to an embodiment of the present disclosure.

FIG. 2 is a block diagram showing the guitar according to the embodiment of the present disclosure.

FIG. 3 is a block diagram showing an internal configuration of an effect applying unit shown in FIG. 2.

FIG. 4 is an enlarged cross-sectional view showing an example of a microphone arrangement in the guitar of FIG. 1.

### DETAILED DESCRIPTION OF THE EMBODIMENTS

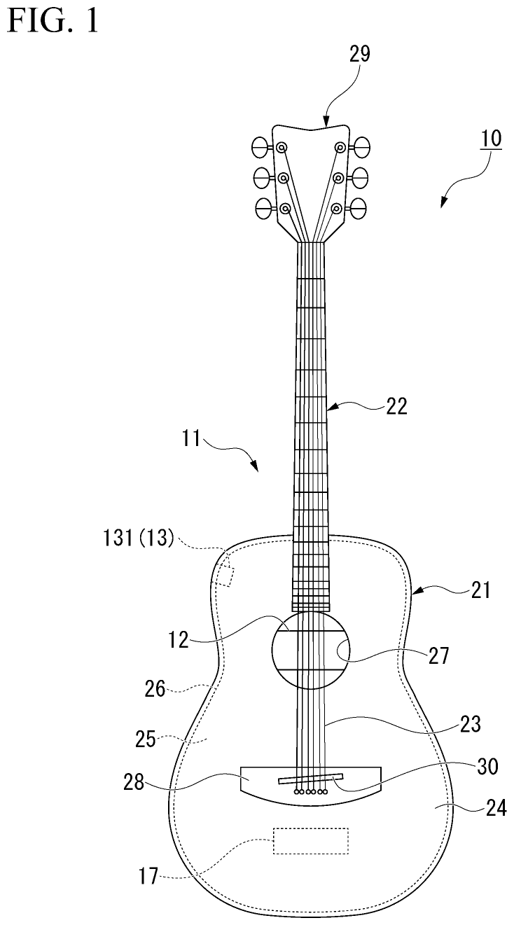

Hereinafter, embodiments of the present disclosure will be described, with reference to FIG. 1 to FIG. 4.

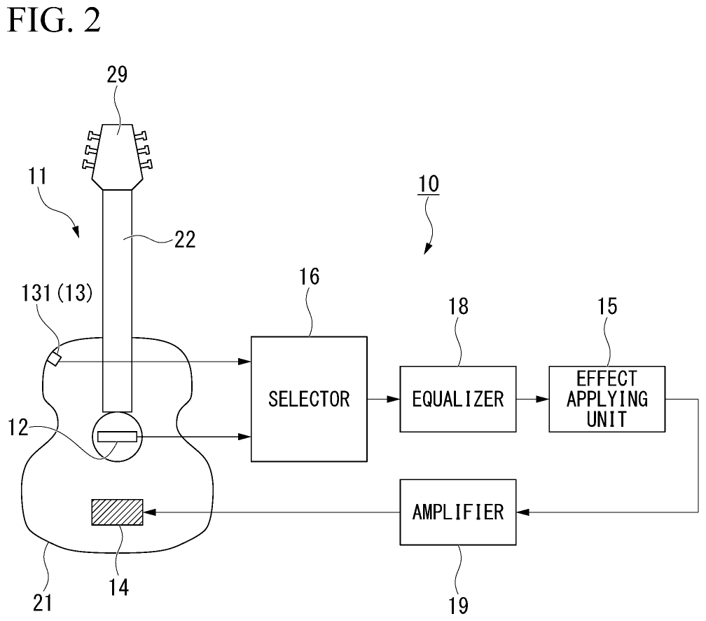

As shown in FIG. 1 and FIG. 2, the musical instrument of the present embodiment is an acoustic guitar 10 (hereinafter, simply referred to as guitar 10), which is a type of stringed musical instrument. The guitar (musical instrument) 10 includes a guitar body 11 (musical instrument body, instrument body), a performance information output unit 12, a sound collection signal output unit (sound collection signal input unit) 13, and a vibration unit (vibrator) 14. Moreover, the guitar 10 of the present embodiment further includes an effect applying unit 15 and a selector 16. The selector 16 may be a conventional input switching circuit.

As shown in FIG. 1, the guitar body 11 includes a body (acoustic unit, housing) 21, a neck 22 and strings (vibrating member) 23. The body 21 is formed in a box shape having therein a cavity. The body 21 has a front plate 24, a back plate 25, and a side plate 26. The front plate 24 and the back plate 25 are flat plates having the same shape. The front plate 24 and the back plate 25 are arranged spaced apart from one another along in the thickness direction thereof. The side plate 26 extends from the circumferential edge of the back plate 25 to the circumferential edge of the front plate 24. The front plate 24, the back plate 25, and the side plate 26 form the body 21 having therein the cavity.

In the front plate 24 of the body 21 there is formed a sound hole 27 penetrating therethrough in the thickness direction thereof. The sound hole 27 communicates the cavity of the body 21 with the space outside the body 21. Moreover, on an outer surface of the front plate 24 there is provided a bridge 28 for fastening a first end of each string 23 in the lengthwise direction.

The neck 22 extends in a direction away from the body 21. At a distal end of the neck 22 there is provided a headstock 29 for winding up a second end side of each string 23 in the lengthwise direction.

The strings 23 are strung over the body 21 and the neck 22. Specifically, the first end of each string 23 is fastened to the bridge 28 on the body 21, and the second end of each string 23 is wound at the headstock 29. As a result, the strings 23 are strung between the bridge 28 and the headstock 29.

Between the strings 23 strung above the outer surface of the front plate 24, and the outer surface of the front plate 24 there is provided a vibration transmitting unit 30 (saddle). Therefore, in the guitar 10, as a result of the performer plucking the string 23, vibration of the string 23 is transmitted to the front plate 24 via the vibration transmitting unit 30, thereby vibrating the front plate 24. As a result, the air inside the body 21 (cavity) resonates, and the sound is radiated to the outside of the body 21. That is to say, in the guitar 10 of the present embodiment, the body 21 is configured as an acoustic unit that vibrates in response to performance operations and makes sound reverberate.

The performance information output unit 12 outputs a performance information signal (performance signal) corresponding to the performance operation mentioned above. The performance information output unit 12 in the present embodiment is a pickup that detects vibration of the string 23 and outputs a string vibration signal according to the vibration as a performance information signal. The performance information output unit 12 is preferably arranged at the position where the sound hole 27 of the front plate 24 is formed, for the purpose of not inhibiting the vibration of the front plate 24 associated with the vibration of the strings 23.

The sound collection signal output unit 13 is provided in the guitar body 11. The sound collection signal output unit 13 receives a sound collection signal corresponding to the sound collected around the guitar body 11. The sound collection signal output unit 13 in the present embodiment is a microphone 131 that collects sounds around the guitar body 11.

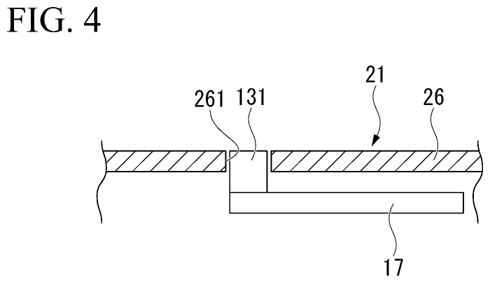

As shown in FIG. 4, the microphone 131 of the present embodiment is provided inside the body 21 (housing) and exposed to the outside of the body 21. Specifically, the microphone 131 is mounted on a circuit board 17 arranged inside the body 21 and exposed to the outside of the body 21 through a through hole 261 formed in the side plate 26. In FIG. 4, the microphone 131 is inserted into the through hole 261 of the side plate 26 to the extent that it does not protrude from the outer surface of the side plate 26 to the outside of the body 21. It should be noted that the microphone 131 may be exposed to the outside of the body 21, for example, through the front plate 24 or the back plate 25 of the body 21.

It is preferable that the microphone 131 be provided on the outer surface of the body 21 facing toward the performer's head (particularly the mouth) when the performer plays the guitar body 11. The microphone 131 may be provided, for example, at the upper left corner of the body 21 when the guitar body 11 is viewed from the front, as shown in FIG. 1. By placing the microphone 131 near the performer's head (particularly the mouth), the microphone 131 can easily collect the voice (for example, singing voice) emitted by the performer. It should be noted that the installation position of the microphone 131 is not limited to the body 21. The microphone 131 may be provided on the neck 22, for example.

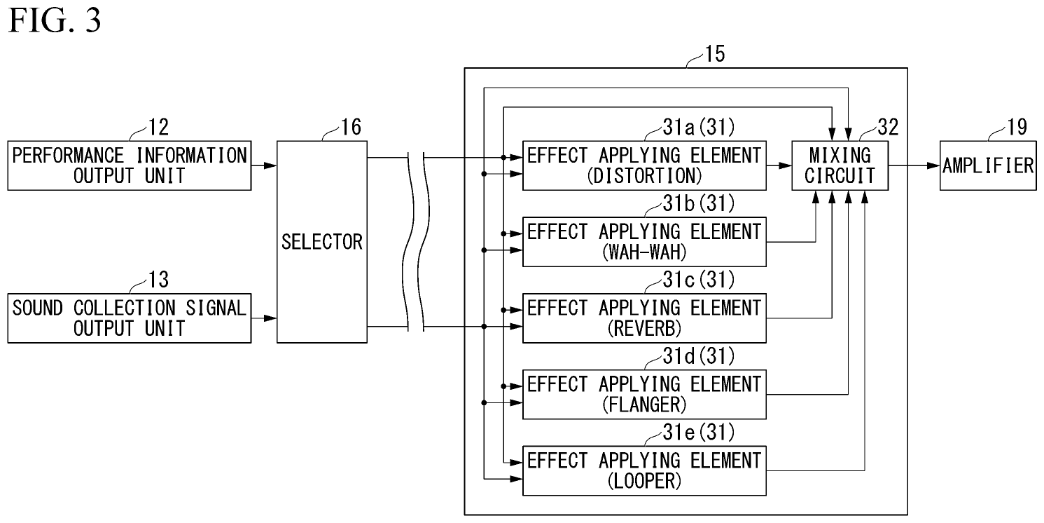

The effect applying unit 15 (effector, sound processor) shown in FIG. 2 and FIG. 3 generates a sound signal (so-called wet sound) in which a musical or acoustic effect has been applied to a performance information signal and a sound collection signal output from the sound collection signal output unit 13, and outputs the sound signal.

The effect applying unit 15 includes effect applying elements 31 (effect elements 31) that apply various predetermined musical or acoustic effects such as distortion-type effect, filter-type effect, spatial-type effect, modulation-type effect, and pitch-type effect to one or more performance information signals and sound collection signals. Specific examples of the effect applying elements 31 (effect elements 31) include a distortion for distortion types, a wah-wah for filter types, a reverb for spatial types, a flanger for modulation types, and an octaver for pitch types. Other specific examples of the effect applying elements 31 (effect elements 31) include a looper. Still other specific examples of the effect applying elements 31 may include a delay, a chorus, a tremolo/vibrato, and a pitch shifter/harmonizer. The effect applying unit 15 may include only one effect applying element 31, for example. In the present embodiment, as shown in FIG. 3, the effect applying unit 15 includes a plurality of effect applying elements 31 (31a to 31e) that each applies a different effect.

The effect applying unit 15 further includes a mixing circuit 32. The mixing circuit 32 mixes: the output signal (wet sound) output from the effect applying element 31 in response to a performance information signal and sound collection signal being input to the effect applying unit 15, and the performance information signal that does not pass through the effect applying element 31 and the sound collection signal (dry sound) in arbitrary proportions. Alternatively, the mixing circuit 32 selects either the output signal (wet sound), or the performance information signal that does not pass through the effect applying element 31 and the sound collection signal (dry sound). Furthermore, the mixing circuit 32 outputs the mixed or selected signal as a sound signal to the outside of the effect applying unit 15 (to the vibration unit 14 or amplifier 19, which will be described later). For example, the effect applying unit 15 may output a sound signal that includes only wet sound, or may output a sound signal that is a mixture of wet sound and dry sound.

In FIG. 3, the same effect applying elements 31 (31a to 31e) correspond to the performance information signal and the sound collection signal; however, the present disclosure is not limited to such an example. Separate effect applying elements 31 may correspond to the performance information signal and the sound collection signal. For example, a distortion effect applying element 31a corresponding to the performance information signal and a distortion effect applying element 31a corresponding to the sound collection signal may be provided separately.

The effect applying unit 15 is attached to the guitar body 11. The effect applying unit 15 may be mounted, for example, on the circuit board 17 shown in FIG. 4 together with the aforementioned microphone 131.

As shown in FIG. 2 and FIG. 3, the selector (selection switch) 16 is provided between the performance information output unit 12 and the sound collection signal output unit 13, and the effect applying unit 15. The selector 16 selects whether or not to input the performance information signal and the sound collection signal output from the performance information output unit 12 and the sound collection signal output unit 13 to the effect applying unit 15. Moreover, the selector 16 selects which effect applying element 31 the performance information signal and the sound collection signal are each input to.

The performance information signal and the sound collection signal not being input to the effect applying unit 15 as a result of the selection made by the selector 16 means the sound signal corresponding to the performance information signal and the sound collection signal not being output from the effect applying unit 15, or only the sound signal corresponds to the dry sound being output from the effect applying unit 15.

In the present embodiment, the selector 16 individually performs a selection of whether or not to input the performance information signal to the effect applying unit 15, and a selection of whether or not to input the sound collection signal to the effect applying unit 15. As a result, by operating the selector 16, it is possible to input only the performance information signal to the effect applying unit 15, or input only the sound collection signal to the effect applying unit 15. Moreover, by operating the selector 16, it is possible to input both the performance information signal and the sound collection signal to the effect applying unit 15. It should be noted that the selector 16 may collectively select whether or not to input the performance information signal and the sound collection signal to the effect applying unit 15.

The selector 16 can be operated by the performer or the like of the guitar 10. That is to say, the selector 16 includes an operating element operated by a performer or the like.

As with the effect applying unit 15, the selector 16 is attached to the guitar body 11. The selector 16 may be mounted, for example, on the circuit board 17 shown in FIG. 4 together with the aforementioned microphone 131.

As shown in FIG. 1 and FIG. 2, the vibration unit 14 is attached to the body 21 of the guitar body 11. The vibration unit 14 vibrates the body 21 on the basis of the performance information signal and the sound collection signal. When the vibration unit 14 vibrates the body 21, sound corresponding to the performance information signal and the sound collection signal is radiated to the outside of the body 21. Here, the sound corresponding to the performance information signal is a performance sound corresponding to a performance operation performed on the guitar 10 (for example, an operation of plucking a string) by the performer. Moreover, the sound corresponding to the sound collection signal is a sound corresponding to the sound collected around the guitar body 11 (for example, the singing voice of the performer). The vibrator 14 may be an electro-acoustic transducer of a commonly known voice coil type or of any other type.

In the present embodiment, the vibration unit 14 can vibrate the body 21 on the basis of a sound signal output from the effect applying unit 15 according to the performance information signal and the sound collection signal. In such a case, the sound in which the effect applying unit 15 has applied an effect to the performance information signal and the sound collection signal is radiated to the outside of the body 21.

The vibration unit 14 may be attached, for example, to the side plate 26. It is preferable that the vibration unit 14 be attached to the front plate 24 or the back plate 25. Also, it is more preferable that the vibration unit 14 be attached to the inner surface of the front plate 24 or the back plate 25.

As shown in FIG. 2, the guitar 10 of the present embodiment further includes an equalizer 18. The equalizer 18 adjusts the frequency characteristics of the performance information signal and the sound collection signal output from the performance information output unit 12 and the sound collection signal output unit 13, respectively. Specifically, the equalizer 18 adjusts the frequency characteristics of the performance information signal and the sound collection signal to characteristics that suppress the fundamental tone frequency region of the guitar body 11 (the body 21 in particular).

It is sufficient that the equalizer 18 be provided at least between the performance information output unit 12 and the sound collection signal output unit 13, and the vibration unit 14. That is to say, the equalizer 18 may be arranged so that the vibration unit 14 vibrates the body 21 on the basis of the signal output from the equalizer 18. In the present embodiment, the equalizer 18 is provided between the performance information output unit 12 and the sound collection signal output unit 13, and the effect applying unit 15. For this reason, the equalizer 18 outputs the performance information signal and the sound collection signal with adjusted frequency characteristics, to the effect applying unit 15.

As with the effect applying unit 15, the equalizer 18 is attached to the guitar body 11. The equalizer 18 may be mounted, for example, on the circuit board 17 shown in FIG. 4 together with the aforementioned microphone 131.

The guitar 10 of the present embodiment further includes an amplifier 19 that amplifies the input signal. The amplifier 19 may be provided at least between the performance information output unit 12 and the sound collection signal output unit 13, and the vibration unit 14. That is to say, it is sufficient that the amplifier 19 be arranged so as to amplify the signal input from the performance information output unit 12 and the sound collection signal output unit 13, and output the amplified signal to the vibration unit 14. In the present embodiment, the amplifier 19 is provided between the effect applying unit 15 and the vibration unit 14. For this reason, the amplifier 19 amplifies a sound signal output from the effect applying unit 15 and outputs it to the vibration unit 14.

As with the effect applying unit 15, the amplifier 19 is attached to the guitar body 11. The amplifier 19 may be mounted, for example, on the circuit board 17 shown in FIG. 4 together with the aforementioned microphone 131.

As described above, the guitar 10 of the present embodiment includes the performance information output unit 12 that outputs a performance information signal corresponding to the performance operation, and the sound collection signal output unit 13 that is provided on the guitar body 11 and inputs a sound collection signal corresponding to the sound collected around the guitar body 11. Moreover, in the guitar 10 of the present embodiment, the vibration unit 14 vibrates the body 21 of the guitar body 11 on the basis of the performance information signal and the sound collection signal.

As a result, the body 21 can output both the performance sounds corresponding to the performer's performance operations performed on the guitar 10 (for example, the operation of plucking the strings) and the sounds collected around the guitar body 11 (for example, singing voice). That is to say, the vibration unit 14 and the body 21 can function as a speaker that outputs both the performance sound of the guitar 10 and the collected sound. As a result, it is possible to reduce equipment preparation for singing and playing the instrument at the same time.

Moreover, in the guitar 10 of the present embodiment, the vibration unit 14 can vibrate the body 21 of the guitar body 11 on the basis of sound signals in which a musical or acoustic effect has been applied to the performance information signal and the sound collection signal. As a result, it is possible to output from the body 21 sounds in which a musical or acoustic effect has been applied to the performance information signal (for example, performance sound of the guitar 10) and the sound collection signal (for example, singing voice).

Moreover, the guitar 10 of the present embodiment includes the selector 16 that performs a selection of whether or not to input a performance information signal and a sound collection signal to the effect applying unit 15. As a result, the performer of the guitar 10 can freely select whether or not to apply a musical or acoustic effect to the performance information signal and the sound collection signal by operating the selector 16.

Moreover, in the guitar 10 of the present embodiment, the selector 16 individually performs a selection of whether or not to input the performance information signal to the effect applying unit 15 and a selection of whether or not to input the sound collection signal to the effect applying unit 15. As a result, it is possible to apply an effect only to the performance information signal or only to the sound collection signal.

Moreover, the guitar 10 of the present embodiment includes the equalizer 18 that adjusts frequency characteristics of the performance information signal and the sound collection signal, to characteristics that suppress the fundamental tone frequency region of the guitar body 11. Moreover, the vibration unit 14 vibrates the body 21 of the guitar body 11 on the basis of a signal output from the equalizer 18 according to the performance information signal and the sound collection signal. As a result, it is possible to suppress howling from occurring in the sound generated from the body 21 in response to the performance operation (live sound).

Moreover, in the guitar 10 of the present embodiment, the sound collection signal output unit 13 is the microphone 131 that collects sounds around the guitar body 11. The microphone 131 is provided inside the body 21 (housing) of the guitar body 11 and exposed to the outside of the body 21. As a result, the microphone 131 can be provided in the guitar body 11 while making the presence of the microphone 131 discreet. That is to say, the guitar 10 of the present embodiment has an advantage in that the appearance of the guitar body 11 does not change even with the microphone 131 provided therein.

The present disclosure has been described in detail above; however, the present disclosure is not limited to the above embodiment, and various modifications may be made without departing from the scope of the present disclosure.

In the present disclosure, the sound collection signal output unit may be, for example, a microphone plug or a jack to which a cable plug connected to the microphone is connected. In such a case, the jack plays the role of inputting a sound collection signal corresponding to the sound collected by the microphone.

Moreover, the sound collection signal output unit may be configured so as to input the sound collection signal mentioned above via wireless communication, for example.

The above description has been made using an acoustic guitar as a specific example of a musical instrument; however, the musical instrument to which the present disclosure is applied is not limited to acoustic guitars. The present disclosure may be applied to a musical instrument having a hollow body and a neck. For example, the present disclosure is applicable also to stringed musical instruments having at least a musical instrument body and a string attached to the musical instrument body, such as a violin, a viola, a cello, and a contrabass.

Furthermore, the present disclosure is applicable not only to stringed instruments but also to other musical instruments such as a piano (for example, acoustic piano) and a percussion instrument.

For example, when the musical instrument of the present disclosure is applied to a piano, the housing, keyboard, soundboard, and so forth of the piano are included in the musical instrument body of the present disclosure. Moreover, a piano soundboard that vibrates and makes sound as the performer operates the keyboard corresponds to the acoustic unit of the present disclosure. Such a piano may include, as the performance information output unit of the present disclosure, a key sensor that detects a keyboard operation, and a sound source circuit that outputs a performance information signal (sound source signal) preliminarily prepared according to a keyboard operation when the key sensor detects a keyboard operation.

For example, when the musical instrument of the present disclosure is applied to a cajon, which is a type of percussion instrument, the housing, struck part, and so forth of the cajon are included in the musical instrument body of the present disclosure. Moreover, the housing of a cajon, which vibrates and makes sound as the performer performs a striking operation on the struck part thereof, corresponds to the acoustic unit of the present disclosure. For example, such a cajon may include a pickup that detects vibrations of the cajon housing as the performance information output unit of the present disclosure, as with the guitar 10 of the above embodiment.

Furthermore, the effect applying elements 31 (effect elements 31) of the effect applying unit 15 described above are not limited to those mentioned in the embodiment, and any element that can apply an effect can be applied to the present disclosure.

The present disclosure may be applied to a musical instrument.

According to the present disclosure, it is possible to reduce equipment preparation for singing and playing a musical instrument at the same time.

What is claimed is:

1. A musical instrument comprising:
a musical instrument body configured to reverberate by vibrating at least one vibrating member in accordance with a performance operation;
a pickup configured to output a performance information signal corresponding to the performance operation;
a microphone disposed in a vicinity of the musical instrument body and configured to output a sound collection signal corresponding to sounds around the musical instrument body; and
a vibrator configured to vibrate the musical instrument body based on the performance information signal and the sound collection signal.

2. The musical instrument according to claim 1, further comprising:
a sound processor configured to apply a sound effect to at least one of the performance information signal or the sound collection signal, to generate an output signal applied with the sound effect,
wherein the vibrator is configured to vibrate the musical instrument body based on the output signal.

3. The musical instrument according to claim 2, further comprising a selector switch configured to selectively input:
neither the performance information signal nor the sound collection signal to the sound processor; or
at least one of the performance information signal or the sound collection signal to the sound processor.

4. The musical instrument according to claim 2, wherein the selector switch is configured to individually select inputting of the performance information signal and the sound collection signal to the sound processor.

5. The musical instrument according to claim 1, further comprising:
an equalizer configured to adjust a frequency characteristic of the performance information signal and a frequency characteristic of the sound collection signal, to suppress a fundamental tone frequency region of the musical instrument body,
wherein the vibrator is configured to vibrate the musical instrument body based on the performance information signal and the sound collection signal whose frequency characteristics have been adjusted.

6. The musical instrument according to claim 1, wherein the microphone is:
configured to collect sounds around the musical instrument body; and
at least partly disposed inside the musical instrument body or at least partly disposed exposed outside the musical instrument body.

7. The musical instrument according to claim 1, further comprising:
the at least one vibrating member,
wherein the at least one vibrating member comprises a string disposed relative to the body that vibrates in response to the performance operation and cause the musical instrument body to vibrate, and
wherein the pickup is configured to detect vibrations of the string and output the performance information signal according to the vibrations.
